(19) United States
(12) Patent Application Publication
(10) Pub. No.: US 2024/0170806 A1
(43) Pub. Date: May 23, 2024

(54) High-Voltage Storage Device With Small-Sized Cell Connector Assembly

(71) Applicant: Bayerische Motoren Werke Aktiengesellschaft, Muenchen (DE)

(72) Inventor: Manuel WINKLER, Chemnitz (DE)

(21) Appl. No.: 18/281,457

(22) PCT Filed: Apr. 11, 2022
(86) PCT No.: PCT/EP2022/059629

§ 371 Date: Sep. 11, 2023

(30) Foreign Application Priority Data
May 10, 2021 (DE) 10 2021 112 139.6

(51) Int. Cl. H01M 50/509; H01M 50/213

(52) U.S. Cl. CPC H01M 50/509; H01M 50/213

(57) ABSTRACT

The present subject matter relates to a cell connector assembly for a battery cell of an assembly of battery cells. A serial connector electrically connects a circular annular ring pole of the battery cell to an inner pole of the opposite polarity of at least one other battery cell of the assembly. A parallel connector connects the ring pole to a ring pole of the same polarity of at least one respective other battery cell. The serial connector and the parallel connector and/or at least two parallel connectors are mutually spaced on the ring pole in the circumferential direction. A multi-cell high-voltage storage device includes multiple battery cells, each of which has an inner pole and a circular annular ring pole arranged radially about the inner pole. A cell connector set comprises multiple cell connectors configured to connect the battery cells of the high-voltage storage device together.

### BACKGROUND AND SUMMARY OF THE INVENTION

The present subject matter relates to a multi-cell high-voltage storage device having a plurality of cylindrical round cells and at least one cell connector set.

In various battery-electric (BEV) and plug-in hybrid (PHEV) driven motor vehicles, multi-cell high-voltage storage devices having round cells are installed as traction batteries. Often, in this instance, the individual battery cells are often connected to each other via flat, relatively extensive cell connector sheet structures which at the terminal side of the cells, which are arranged in a plane, of the high-voltage storage device take over all or at least a large number of the series (s) and parallel (p) electrical connections between the cells.

As a result of the increasingly high line cross sections which are required, the cell connectors are in this instance becoming increasingly wide and cover increasingly large regions of the cell surface. In addition, they are complex to produce, require a high material use and are consequently also heavy.

DE 10 2018 208 896 A1 discloses a battery module having T-shaped and cross-shaped cell connectors. For a battery module, however, many different structural types of these cell connectors are required.

Against this background, an object of the present subject matter is to improve a cell connection of a multi-cell high-voltage storage device.

According to one aspect, there is disclosed a cell connector arrangement for a battery cell of an assembly of cylindrical round battery cells which is arranged in particular hexagonally in a packing plane of a multi-cell high-voltage storage device, having: (a) a series connector for electrical connection of a circular annular pole of the battery cell to a non-identical inner pole of at least one additional battery cell of the battery cell assembly and (b) at least one parallel connector for connecting the annular pole to an identical annular pole of at least one additional battery cell.

The series connector and at least one of the parallel connectors and/or at least two of the parallel connectors are arranged on the annular pole so as to be spaced apart from each other in a circumferential direction.

In particular, the spacing between the connection locations of the mutually spaced-apart series and/or parallel connectors exists so that in particular a flow line between the cell connectors which are spaced apart on the annular pole can be carried out exclusively via the annular pole itself.

Since the different series and/or parallel connectors of the cell connector arrangement are connected to the annular pole in a manner spaced apart from each other, in the multi-cell high-voltage storage device the respective annular pole of the round cell is used for electrical conduction when the cells are connected. The series and/or parallel connectors can thereby be constructed to be smaller. Material can be saved. As a result of the small construction, better accessibility of the round cells is further retained, for example, for adhesively-bonding and/or casting the cell assembly.

As a result of the use of the annular pole as a connection conductor, cell connector sets which comprise a relatively large number of small cell connectors are enabled, instead of as with conventional round cell high-voltage storage devices using one or a few extensive and/or complex-to-produce cell connectors for a large number of round cells. The individual, small cell connectors are substantially less complex to produce. The use thereof can further be carried out in a more flexible manner so that batch quantity effects can be achieved since identical cell connectors for different parallel interconnection patterns can be used, where applicable even with slightly different cell geometries.

An assembly of battery cells is in this instance in particular intended to be understood to be a plurality of battery cells which together form a packing plane of a multi-cell high-voltage storage device or a portion, in particular a cell bundle, thereof, and are to this end fixed with respect to each other in terms of their positions and orientations.

According to another aspect, a multi-cell high-voltage storage device is disclosed having a plurality, in particular a large number of hexagonally arranged, cylindrical round battery cells which—in each case at the same cylinder head side—have an inner pole and a circular annular pole which is arranged radially around it.

The multi-cell high-voltage storage device has on a cell connector set having a plurality of cell connectors which are configured, in particular with cooperation of the cell connectors, to interconnect the battery cells of the high-voltage storage device, in particular according to an interconnection specification, so that a cell connector arrangement according to an example of the present subject matter is produced, that is to say, in particular the series connectors and/or the parallel connector of the cell connectors of the cell connector set are constructed in such a manner that in the installed state on the annular pole of the respective battery cell they are arranged spaced apart from each other in the circumferential direction.

According to one example, at least one series connector and parallel connector, in particular in the form of a cell connector of the cell connector set, are constructed integrally with each other.

Consequently, a small cell connector base unit can be provided, particularly when the cell connector actually connects one of the round cells exclusively to another round cell in series and to a maximum of one or two or three other round cells in parallel.

The present subject matter is based inter alia on the consideration that, with known cell connectors, p-connections of a plurality of cells are produced by means of a connector which is specific to the p-connection. Each p-connection then has in the known solutions an individual connector specific to the p-connection.

This requires a high level of complexity of the connectors for p-interconnections, a relatively high material use and with a design for a connector there is also always a determination in terms of a specific p-interconnection diagram.

The present subject matter is based inter alia on the notion of dividing the complex large connectors of a multiple p-connection in the known solutions into smaller sub-connectors.

In this instance, there is a reduction of the size (simpler producibility with similar complexity) of the individual cell connector for a multiple p-interconnection of round cells. The cell—specifically a circular-ring-like pole of the cell—is in this instance used as a conductor and material can be saved. Different p connections can be produced with a consistently identical set of connectors.

According to one example, the cell connector set has at least one integral series and parallel connector per four or three or two, in particular hexagonally arranged, round cells. Consequently, a small cell connector concept can be implemented, with the above-described advantages.

According to one example, the integral series and parallel connector connects the inner pole of a round cell to precisely two or three annular poles of adjacent round cells. Such a cell connector has the smallest possible construction size for the respective connection case. In particular, the connection may be used with precisely two annular poles or precisely three annular poles with different parallel interconnection configurations (for example, Xs2p, Xs3p, Xs4p, Xs5p, Xs6p, Xs7p, Xs8p) with a minimal structural size. The tendency is in this instance with a parallel interconnection of a smaller number of cells (for example, 2p, 3p, 4p) rather to assume a connection of two annular poles to a cell connector, with a parallel interconnection of a larger number of cells (for example, 5p, 6p, 7p, 8p) rather to assume a connection of three or even four or five annular poles. The number of annular poles which are connected to a cell connector is, however, per se independent of the provided parallel interconnection patterns and in the individual case also dependent on other application-specific circumstances beyond the provided parallel interconnection pattern.

According to one example, the cell connector set has no more than two different types or only a single type of integral series and parallel connectors in order to thereby achieve a cell connector arrangement according to an example of the present subject matter. The use of small-sized s/p cell connectors as a basic type of cell connectors in a multi-cell high-voltage storage device enables a simple production of the required cell connections in the high-voltage storage device. In particular, for high-voltage storage devices having a single row of parallel interconnection pattern and/or a low p number (for example, Xs2p and most Xs3p configuration), a single type of s/p cell connectors may be sufficient—with the exception of connection connectors with regard to a power terminal of the high-voltage storage device. For high-voltage storage devices having two—row 6p configurations (or other p configurations having more than two or three cells interconnected in parallel), in particular two types of s/p cell connectors may in particular be sufficient.

According to one example, a type of integral series and parallel connectors is arranged in at least two different installation positions, in particular with different flat sides toward the round cells. Consequently, in specific configurations an in particular planar non-symmetrical cell connector having two different mirror-symmetrical installation positions can be installed so that, in spite of a requirement for two geometrically different cell connectors, a single type of cell connectors can be used.

According to one example, the cell connector set has between half and three-quarters, in particular two-thirds, as many cell connectors as round cells. This proportion, in particular two-thirds, is produced from a use of the smallest possible cell connectors and enables a maximum material saving, batch quantity effects and low production complexity.

According to one example, in the multi-cell high-voltage storage device, in particular in a cell plane, at least eight or ten or twelve cells or parallel-connected cell bundles are connected in series in order to obtain a desired output voltage.

According to one example, in the multi-cell high-voltage storage device, in particular in a cell plane, at least two or three cells are connected in parallel to form cell bundles in order to obtain a desired output current strength.

According to one example, the cell connector set has both purely series connectors and integral series and parallel connectors. Consequently, other interconnection concepts can be produced.

According to one example, at least one of the parallel connectors has a securing device, in particular a securing recess. Consequently, there can be achieved an extremely simple parallel securing which, as a result of its multiple parallel arrangement, only has to secure against relatively low current flows and consequently can in particular be in the form of a purely cross-sectional reduction, for example, by means of a recess.

According to another aspect, a multi-cell high-voltage storage device is disclosed having a plurality, in particular a large number of cylindrical round cells, in one or more cell planes of the high-voltage storage device. In particular, the cylindrical round cells of a cell plane are arranged hexagonally with respect to each other with parallel cylinder center axes. For electrical contacting of the round cells with each other, the multi-cell high-voltage storage device has at least one cell connector set having at least two, in particular a plurality of cell connectors which in each case, for electrical connection of a circular annular pole, which is in particular arranged radially externally, of one of the round cells on an upper side of the round cell, are formed with additional round cells which are arranged hexagonally adjacent to the first round cell, in particular hexagonally around the first round cell, or in the next identically orientated cell row, that is to say, in the next-but-one cell row. Each of the at least two cell connectors of the cell connector set has in an example according to this aspect at least: (i) a series connector for connecting the annular pole to a non-identical (that is to say, minus instead of plus or vice versa) inner pole of at least one of the additional round cells, and (ii) at least one parallel connector for connecting the annular pole to an identical (that is to say, minus to minus or plus to plus) annular pole of at least one of the additional round cells. The series connector and at least one parallel connector and/or at least two parallel connectors are arranged on the connection pole circular ring so as to be spaced apart from each other in a circumferential direction.

### BRIEF SUMMARY OF THE DRAWINGS

FIG. 1 shows a multi-cell high-voltage storage device according to a first example of the present subject matter with an Xs2p interconnection,

FIG. 2 shows a multi-cell high-voltage storage device according to a second example of the present subject matter with an Xs3p interconnection,

FIG. 3 shows a multi-cell high-voltage storage device according to a third example of the present subject matter with an Xs3p interconnection,

FIG. 4 shows a multi-cell high-voltage storage device according to a fourth example of the present subject matter with an Xs6p interconnection.

### DETAILED DESCRIPTION

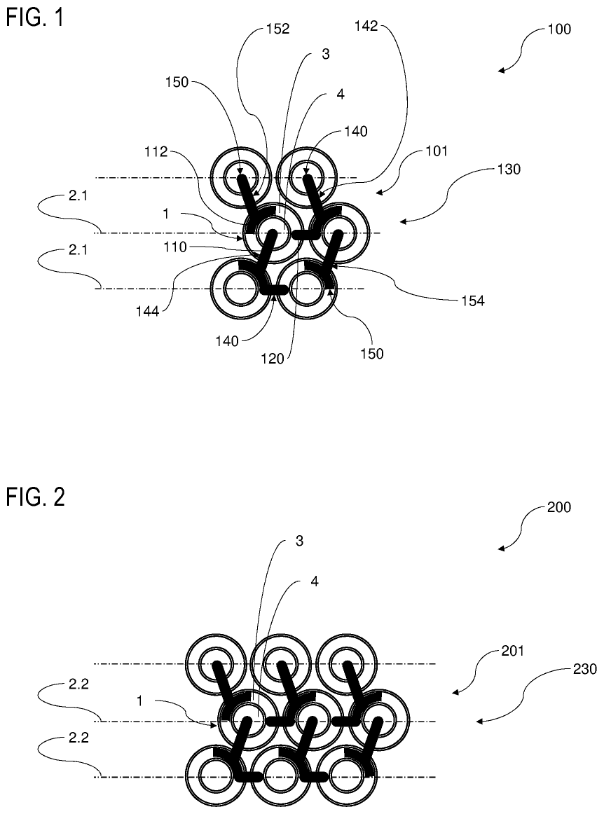

FIG. 1 shows a cut-out of a multi-cell high-voltage storage device 100 according to a first example of the present subject matter with an Xs2p interconnection of a plurality of battery cells 1, in this instance cylindrical round cells.

The cylindrical battery cells 1 are arranged with respect to each other in a hexagonal package, that is to say, the battery cells 1 are arranged with respect to their main longitudinal axis (perpendicularly to the drawing plane) parallel with each other, wherein each of the battery cells 1 is surrounded by six additional battery cells which are arranged in a state distributed in a uniform manner on a notional circular line about the main longitudinal axis of the central battery cell 1. Naturally, each of the battery cells 1 is not actually surrounded by six additional battery cells—this image is intended only to illustrate the manner of arrangement.

Each of the battery cells 1 has an inner pole 3 which in the examples is at one of the end faces of the cylindrical extent of the battery cell about the main longitudinal axis thereof in the form of a central pole. Radially at the outer side of the inner pole 3, each of the battery cells 1 has a circular annular pole 4 which is constructed in a non-identical manner to the inner pole 3, that is to say, it has the other direct-current polarization.

In the Xs2p interconnection, two cylindrical battery cells 1 are connected in parallel to form a cell bundle 2.1. A predetermined number of—that is to say, X—cell bundles 2.1 are connected to each other in series.

The high-voltage storage device 100 has a cell connector arrangement 101 which enables the Xs2p interconnection so that at least with each battery cell 1 which is not arranged at an interconnection interface to the environment (that is to say, at least at each standard-connected battery cell of the high-voltage storage device) on the annular pole 4 a series connector 110 for connection to the inner pole of an adjacent battery cell and a parallel connector 120 for connection to the annular pole of another adjacent battery cell are arranged.

The series connector 110 and the parallel connector 120 are arranged on the annular pole 4 in a circumferential direction U so as to be spaced apart from each other with a minimum spacing A.

Furthermore, on the inner pole 3 of the battery cell 1, another series connector 112 for electrical connection to the annular pole of another different battery cell is arranged.

The cell connector arrangement 101 is achieved by means of a cell connector set 130 which in the example has only two types of cell connectors 140 and 150.

The cell connector type 140 is configured to connect a battery cell 1 on the annular pole 4 thereof both in series to an inner pole of an adjacent battery cell and in parallel to an annular pole of another adjacent battery cell. The cell connector type 140 forms as a single component the series connector 110 and the parallel connector 120.

The cell connector type 150 is configured to connect a battery cell 1 at the annular pole 4 thereof exclusively in series to an inner pole of an adjacent battery cell. The cell connector type 150 forms as a single component the series connector 112.

In the high-voltage storage device 100, the cell connector arrangement 101 is achieved in that the cell connector type 140 is used in a first installation position 142 and a transposed second installation position 144, and the cell connector type 150 in a first installation position 152 and a transposed second installation position 154.

With the cell connector set 130, the cell connector arrangement 101 for constructing the cell contacting system enables the use of a large number of small cell connectors which are all intended to be associated with only two different cell connector types 140 and 150 so that only two different components which can also be produced in an extremely simple manner and in high batch numbers have to be used.

In the example, six battery cells 1 which are interconnected by means of four cell connectors in the context of the cell connector arrangement 101 are illustrated. Two of the four cell connectors are of the type 140 (installed in the different installation positions 142 and 144). The other two of the four cell connectors are of the type 150 installed in the different installation positions 152 and 154).

In FIG. 2, a cut-out of a multi-cell high-voltage storage device 200 according to a second example of the present subject matter is illustrated with an Xs3p-interconnection.

The high-voltage storage device 200 differs from the high-voltage storage device 100 according to FIG. 1 in particular in that the individual cell bundles 2.2 have three battery cells 1 which are connected in parallel.

In comparison with the illustration from FIG. 1, it can be seen that a cell connector arrangement 201 of the high-voltage storage device 200 corresponds substantially to the cell connector arrangement 101 from FIG. 1, only in that in each case three battery cells are interconnected in parallel with the cell bundle 2.2.

In the example, nine battery cells 1 are illustrated which are interconnected by means of six cell connectors in the manner of a cell connector arrangement 201. Four of the six cell connectors are of the type 140 (installed in the different installation positions 142 and 144). The other two of the six cell connectors are of the type 150 (installed in the different installation positions 152 and 154).

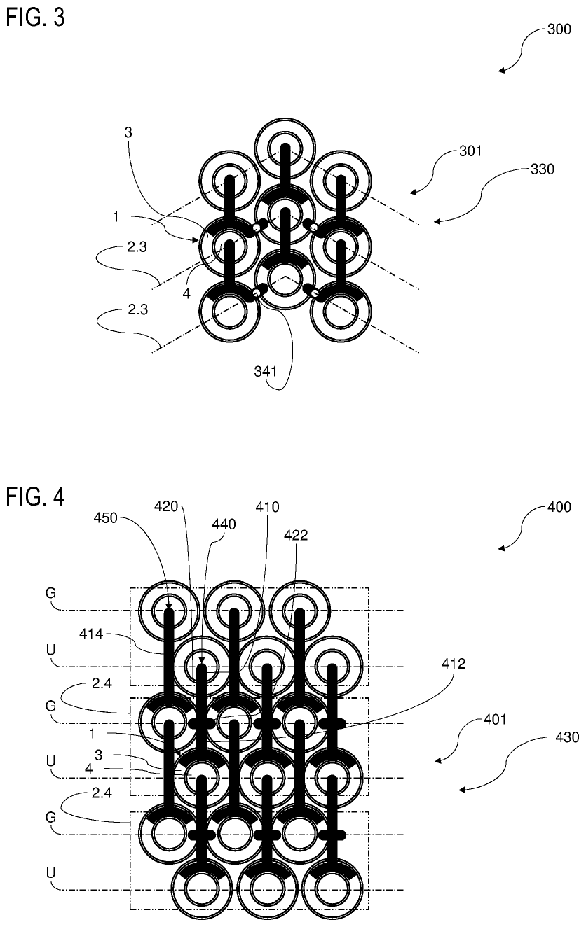

With a slight geometric deviation, a cell connector arrangement 301 of a high-voltage storage device 300 according to the example described in FIG. 3 corresponds to the cell connector arrangement 201 of the high-voltage storage device 200 from FIG. 2.

In FIG. 3, another modification is illustrated by way of example: the cell connectors of the type 340 correspond with the exception of the mentioned geometric deviation functionally to the type 140 from FIGS. 1 and 2; in addition in this instance, however, a recess which acts as an overload current protection 341 for the parallel interconnection of the battery cells 1 for limiting the cross section is introduced.

FIG. 4 shows a cut-out of a multi-cell high-voltage storage device 400 according to a fourth example of the present subject matter with an Xs6p interconnection.

In the Xs6p interconnection, six cylindrical battery cells 1 are connected in parallel in each case to form a cell bundle 2.4. A predetermined number—that is to say, x—of cell bundles 2.4 are interconnected with respect to each other in series.

The high-voltage storage device 400 has a cell connector arrangement 401 which enables the Xs6p interconnection so that a plurality of 3×2 cell bundles 2.4 can be interconnected with respect to each other. In this arrangement, it is necessary to connect battery cells both to battery cells in the directly adjacent cell row and to battery cells in the next-but-one cell row.

To this end, the battery cells of each linear cell row G are also connected in parallel to each other, whereas the battery cells of each non-linear cell row U are connected only in series.

On the annular pole 4 of a battery cell 1 of a linear cell row, two parallel connectors 420 and 422 are arranged for connection to the two adjacent battery cells in the same cell row, and a series connector 410 for connection to the inner pole of a battery cell in the next-but-one cell row. All three connectors 410, 420 and 422 are spaced apart from each other in the circumferential direction of the annular pole 4 in such a manner that between the series connector 410 and each of the parallel connectors 420 and 422 there is a spacing A*.

Furthermore, on the inner pole 3 of the battery cell 1 another series connector 412 for electrical connection to the annular pole of another battery cell is arranged in the opposing next-but-one cell row.

A battery cell of a non-linear cell row has a series connector 412 or 414 only on the annular pole thereof and on the inner pole thereof in each case.

The cell connector arrangement 401 is achieved by means of a cell connector set 430 which in the example has only two types of cell connectors 440 and 450.

The cell connector type 440 is configured to connect a battery cell in a linear cell row G on the annular pole 4 thereof both in series to the inner pole of a battery cell in both adjacent, non-linear cell rows U, and in parallel to an annular pole of an adjacent battery cell in the same linear cell row G. The cell connector type 440 consequently forms as a single component a series connector 410 and 412 and in each case a parallel connector 420 and 422.

The cell connector type 450 is in contrast only configured to connect a battery cell in a non-linear cell row U at the annular pole thereof in series to an inner pole of a battery cell in the next-but-one row, that is to say, the next non-linear cell row U. The cell connector type 150 consequently forms the series connector 414 as a single component.

With the cell connector set 430, the cell connector arrangement 401 enables for construction of the cell contacting system a use of a large number of small cell connectors which are all intended to be associated only with two different cell connector types 440 and 450 so that only two different components which can also be produced in an extremely simple manner and in high batch numbers have to be used.

In the example, eighteen battery cells 1 which are interconnected by means of twelve cell connectors in the manner of the cell connector arrangement 401 are illustrated. Six of the twelve cell connectors are of the type 440 or of the type 450 in each case.

### LIST OF REFERENCE NUMERALS

1 Battery cells, in this instance cylindrical round cells
2 Cell bundles
3 Inner pole, in this instance central pole, of a battery cell
4 Annular pole of a battery cell
100, 200, 300, 400 Multi-cell high-voltage storage device
101, 201, 301, 401 Cell connector arrangement
110, 112, 410, 412, 414 Series connector
142, 144 Installation positions of a cell connector of the type 140
152, 154 Installation positions of a cell connector of the type 150
120, 420, 422 Parallel connectors
130, 230, 330, 430 Cell connector set
140, 150, 440, 450 Cell connector types
341 Overload current protection
A, A* Smallest spacing of two cell connectors on an annular pole
G Linear cell row
U Non-linear cell row

1.-10. (canceled)

11. A cell connector arrangement for a battery cell of an assembly of battery cells, comprising:
a cell bundle comprising:
a series connector configured to electrically connect a circular annular pole of the battery cell to a non-identical inner pole of at least one additional battery cell of the assembly; and
a parallel connector configured to electrically connect the circular annular pole to an identical annular pole of an additional battery cell, wherein
the series connector and the parallel connector and/or at least two additional parallel connectors are arranged on the annular pole so as to be spaced apart from each other in a circumferential direction.

12. A multi-cell high-voltage storage device, comprising:
a plurality of battery cells each having an inner pole and a circular annular pole that is arranged radially around the inner pole; and
the cell connector arrangement of claim 11.

13. The multi-cell high-voltage storage device according to claim 12, wherein
the series connector and the parallel connector are constructed integrally with each other in order to form a cell connector.

14. The multi-cell high-voltage storage device according to claim 12, wherein
the cell connector arrangement has at least one integral series and/or parallel cell connector for every two, three, or four battery cells.

15. The multi-cell high-voltage storage device according to claim 13, wherein
the integral series and parallel connector electrically connects the inner pole of a round cell to two or three annular poles of adjacent round cells.

16. The multi-cell high-voltage storage device according to claim 13, wherein
the cell connector set has no more than two different types or only a single type of integral series and/or parallel cell connectors.

17. The multi-cell high-voltage storage device according to claim 15, wherein
a type of integral series and/or parallel cell connectors is arranged in at least two different installation positions with different flat sides toward the round cells.

18. The multi-cell high-voltage storage device according to claim 12, wherein
the cell connector set has between one-half and three-quarters as many cell connectors as battery cells.

19. The multi-cell high-voltage storage device according to claim 12, wherein
the cell connector set comprises both individual series cell connectors and integral series and parallel cell connectors.

20. The multi-cell high-voltage storage device according to claim 12, wherein
a parallel connector has a securing a securing recess.
